(19) United States
(12) Patent Application Publication
(10) Pub. No.: US 2007/0047080 A1
(43) Pub. Date: Mar. 1, 2007

(54) METHODS OF PRODUCING MULTILAYER REFLECTIVE POLARIZER

(75) Inventors: Carl A. Stover, St. Paul, MN (US); Eileen M. Haus, St. Paul, MN (US); George M. Jones, Madison, AL (US); Kristopher J. Derks, Woodbury, MN (US); Timothy J. Hebrink, Scandia, MN (US); Kevin M. Hamer, St. Paul, MN (US); William Ward Merrill, White Bear Lake, MN (US); Terence D. Neavin, St. Paul, MN (US); Jeffrey A. Peterson, Lake Elmo, MN (US); Mark J. Pellerite, Woodbury, MN (US); James E. Lockridge, St. Paul, MN (US); Richard J. Thompson, Lino Lakes, MN (US); Barry S. Rosell, Lake Elmo, MN (US); Bert T. Chien, St. Paul, MN (US); Gregg E. Pritchard, Decatur, AL (US); Tammy S. Borges, Bargersville, IN (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 11/467,181

(22) Filed: Aug. 25, 2006

Related U.S. Application Data
(60) Provisional application No. 60/713,620, filed on Aug. 31, 2005.

(51) Int. Cl. G02B 5/30; G02B 27/28

(52) U.S. Cl. 359/497

(57) ABSTRACT

Methods of forming multilayer reflective polarizers are described. One method includes providing a multilayer polymer film having a plurality of alternating polymeric optical layer pairs, heating the multilayer polymer film to a temperature of about or greater than both polymers layer glass transition temperatures to from a heated multilayer film, and stretching the heated multilayer polymer film in an in-plane direction to form a multilayer reflective polarizer. Each first polymer layer includes a first polyester material and each second polymer layer includes a second polyester material that has a different polymer composition than the first polymer layer composition. The stretching includes a uniaxial stretch.

### CROSS REFERENCE TO RELATED APPLICATION

This application claims the benefit of U.S. Provisional Patent Application No. 60/713,620, filed Aug. 31, 2005, the disclosure of which is incorporated by reference herein in its entirety.

### BACKGROUND

The present disclosure relates to multilayer reflective polarizers and methods of making multilayer reflective polarizers.

Polymeric optical films are used in a wide variety of applications such as reflective polarizers. Such reflective polarizer films are used, for example, in conjunction with backlights in liquid crystal displays. A reflective polarizing film can be placed between the user and the backlight to recycle polarized light that would be otherwise absorbed, and thereby increasing brightness. These polymeric optical films often have high reflectivity, while being lightweight and resistant to breakage. Thus, the films are suited for use as reflectors and polarizers in compact electronic displays, such as liquid crystal displays (LCDs) placed in mobile telephones, personal data assistants, portable computers, desktop monitors, and televisions, for example.

One class of polymers useful in creating polarizer films is polyesters. One example of a polyester-based polarizer includes a stack of polyester layers of differing compositions. One configuration of this stack of layers includes a first set of birefringent layers and a second set of layers with an isotropic index of refraction. The second set of layers alternates with the birefringent layers to form a series of interfaces for reflecting light.

The properties of a given polyester are typically determined by the monomer materials utilized in the preparation of the polyester. A polyester is often prepared by reactions of one or more different carboxylate monomers (e.g., compounds with two or more carboxylic acid or ester functional groups) with one or more different glycol monomers (e.g., compounds with two or more hydroxy functional groups). Each set of polyester layers in the stack typically has a different combination of monomers to generate the desired properties for each type of layer. There is a need for the development of reflective polarizers which have improved properties including physical properties, optical properties, and/or that are easier and/or less expensive to manufacture.

### SUMMARY

This disclosure is directed to multilayer reflective polarizers and methods of making multilayer reflective polarizers. In some implementations, this disclosure is directed to methods of making polyester based reflective polarizers utilizing lower draw ratios and draw temperatures to achieve a desired optical power.

One exemplary embodiment includes a method of forming a reflective polarizer. One method includes providing a multilayer polymer film having a plurality of alternating polymeric optical layer pairs, heating the multilayer polymer film to a temperature of about or greater than both polymer layers glass transition temperatures to about 40 degrees centigrade greater than both polymer layers glass transition temperatures, to form a heated multilayer film, and stretching the heated multilayer polymer film in an in-plane direction to a dimension less than five times that direction's unstretched dimension to form a multilayer reflective polarizer. Each optical layer pair includes a first polymer layer and second polymer layer. Each first polymer layer includes a first polyester material having a first glass transition temperature. The second polymer layer includes a second polyester material having a second glass transition temperature and being a different polymer composition than the first polymer layer composition. The stretching includes a uniaxial stretch.

Another exemplary embodiment includes a method of making a multilayer reflective polarizer including providing a multilayer polymer film having a plurality of alternating polymeric optical layer pairs, heating the multilayer polymer film to a temperature of about or greater than both polymer layers glass transition temperatures to about 40 degrees centigrade greater than both polymer layers glass transition temperatures, to form a heated multilayer film, and stretching the heated multilayer polymer film in an in-plane direction to form a multilayer reflective polarizer having an optical power in a range from 1.2 to 2.0 per optical layer pair. Each optical layer pair includes a first polymer layer and second polymer layer. Each first polymer layer includes a first polyester material having a first glass transition temperature. The second polymer layer includes a second polyester material having a second glass transition temperature and being a different polymer composition than the first polymer layer composition. The stretching includes a uniaxial stretch.

A further embodiment includes a method of making a multilayer reflective polarizer including providing a multilayer polymer film having a plurality of alternating polymeric optical layer pairs, heating the multilayer polymer film to a temperature of about or greater than both polymer layers glass transition temperatures to form a heated multilayer film, and stretching the heated multilayer polymer film in an in-plane direction to form a multilayer reflective polarizer having an optical power in a range from 1.2 to 2.0 per optical layer pair. Each optical layer pair includes a first polymer layer and second polymer layer. Each first polymer layer includes a first polyester material having a first glass transition temperature. The second polymer layer includes a second polyester material having a second glass transition temperature and being a different polymer composition than the first polymer layer composition. The stretching includes a uniaxial stretch.

### BRIEF DESCRIPTION OF THE DRAWINGS

The disclosure may be more completely understood in consideration of the following detailed description of various embodiments of the disclosure in connection with the accompanying drawings, in which:

FIG. 1 is a schematic perspective view of one embodiment of a multilayer reflective polarizer constructed and arranged in accordance with the disclosure;

FIG. 2 is a plan view of an illustrative system for forming a reflective polarizer in accordance with of the disclosure; and

FIG. 3 is a contour plot illustrating some results of Example 1.

### DETAILED DESCRIPTION

The following description should be read with reference to the drawings, in which like elements in different drawings are numbered in like fashion. The drawings, which are not necessarily to scale, depict selected illustrative embodiments and are not intended to limit the scope of the disclosure. Although examples of construction, dimensions, and materials are illustrated for the various elements, those skilled in the art will recognize that many of the examples provided have suitable alternatives that may be utilized.

Unless otherwise indicated, all numbers expressing feature sizes, amounts, and physical properties used in the specification and claims are to be understood as being modified in all instances by the term “about.” Accordingly, unless indicated to the contrary, the numerical parameters set forth in the foregoing specification and attached claims are approximations that can vary depending upon the desired properties sought to be obtained by those skilled in the art utilizing the teachings disclosed herein.

Weight percent, percent by weight, % by weight, % wt, and the like are synonyms that refer to the concentration of a substance as the weight of that substance divided by the weight of the composition and multiplied by 100.

The recitation of numerical ranges by endpoints includes all numbers subsumed within that range (e.g. 1 to 5 includes 1, 1.5, 2, 2.75, 3, 3.80, 4, and 5) and any range within that range.

As used in this specification and the appended claims, the singular forms “a”, “an”, and “the” encompass embodiments having plural referents, unless the content clearly dictates otherwise. For example, reference to “a layer” encompasses embodiments having one, two or more layers. As used in this specification and the appended claims, the term “or” is generally employed in its sense including “and/or” unless the content clearly dictates otherwise.

The term “birefringent” means that the indices of refraction in orthogonal x, y, and z directions are not all the same. For the polymer layers described herein, the axes are selected so that x and y axes are in the plane of the layer and the z axis corresponds to the thickness or height of the layer. The term “in-plane birefringence” is understood to be the absolute value of the difference between the in-plane indices (nₓ and n_{y}) of refraction. All birefringence and index of refraction values are reported for 632.8 nm light unless otherwise indicated.

This disclosure is directed to multilayer reflective polarizers and methods of making multilayer reflective polarizers. More specifically, this disclosure is directed to methods of making polyester based reflective polarizers utilizing lower draw ratios and draw temperatures to achieve a desired optical power. In many embodiments, the multilayer reflective polarizers are formed from polymer layers made from polyesters having naphthalate subunits, including, for example, homopolymers or copolymers of polyethylene naphthalate.

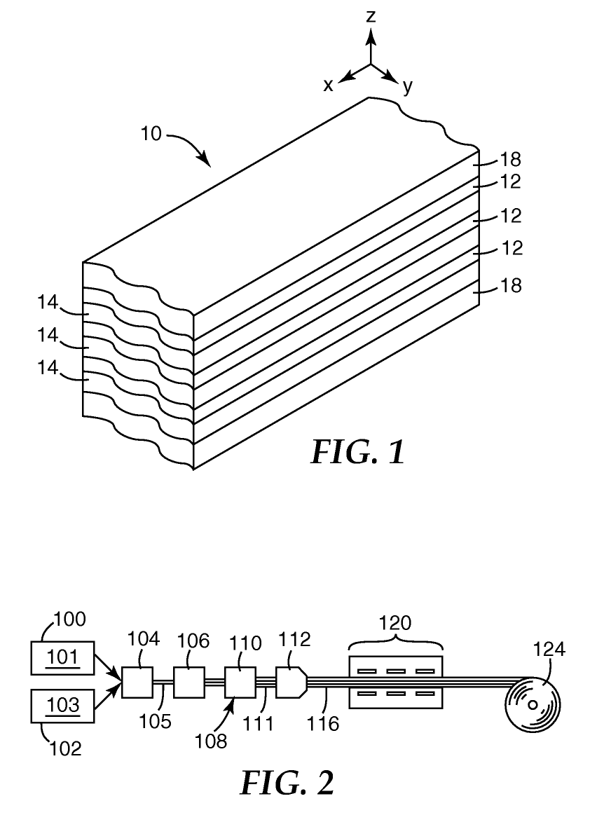

FIG. 1 shows a multilayer reflective polarizer 10 that includes a one or more first polymer layers 12, one or more second polymer layers 14, and optionally, one or more polymer skin (non-optical layers) layers 18. One or more polymer boundary layers and/or other non-optical layers (not shown) can be disposed within the multilayer reflective polarizer, if desired. In some exemplary embodiments, the first polymer layers 12 are optical polymer layers that are capable of becoming birefringent once oriented or stretched, while the second polymer layers 14 are also optical polymer layers that do not become birefringent when stretched. In such exemplary embodiments, the second polymer layer 14 has an isotropic index of refraction, which is usually selected to be different from the indices of refraction of the first polymer layers 12 in one in-plane direction after orientation or stretching, while substantially matching the indices of refraction of the first polymer layers 12 in another in-plane direction. In other exemplary embodiments, the second polymer layers 14 may have other isotropic refractive indexes or they may be negatively or positively birefringent.

Thus, as it is further explained below, the first polymer layers 12 are different than the second polymer layers 14. In many embodiments, first polymer layers 12 have a different polymer composition than the second polymer layers 14, as also further described below. The layers 12, 14, and 18 can be constructed to have different relative thicknesses than those shown in FIG. 1. These various components, along with methods of making the multilayer reflective polarizer 10, are described below.

The optical layers 12, 14 and, optionally, one or more of the non-optical layers are typically placed one on top of the other to form a stack of layers, as shown in FIG. 1. The optical layers 12, 14 are arranged as alternating optical layer pairs where each optical layer pair includes a first polymer layer 12 and a second polymer layer 14, as shown in FIG. 1, to form a series of interfaces between layers with different optical properties. The interface between the two different optical layers (e.g., first and second layers) forms a light reflection plane, if the indices of refraction of the first and second polymer layers are different in at least one direction, e.g., at least one of x, y, and z directions. Light polarized in a plane parallel to the direction in which the indices of refraction of the two layers are approximately equal will be substantially transmitted. Light polarized in a plane parallel to the direction in which the two layers have different indices will be at least partially reflected. The reflectivity can be increased by increasing the number of layers or by increasing the difference in the indices of refraction between the first and second layers. Generally, multilayer optical films can have 2 to 5000 optical layers, or 25 to 2000 optical layers, or 50 to 1500 optical layers, or 75 to 1000 optical layers. A film having a plurality of layers can include layers with different optical thicknesses to increase the reflectivity of the film over a range of wavelengths. For example, a film can include pairs of layers which are individually tuned (for normally incident light, for example) to achieve optimal reflection of light having particular wavelengths. It should further be appreciated that, although only a single multilayer stack may be described, the multilayer optical film can be made from multiple stacks that are subsequently combined to form the film. Other considerations relevant to making multilayer reflective polarizers are described, for example, in U.S. Pat. No. 5,882,774 to Jonza et al., the disclosure of which is hereby incorporated by reference herein to the extent it is not inconsistent with the present disclosure.

In many embodiments, the multilayer optical film exhibits an optical power in a range from 500 to 800 or from 600 to 700. Optical power is calculated by taking dark state on-axis transmission measurements (% T) (with a spectrophotometer such as, for example a Lambda 19 spectrophotometer) between the 50% transmission band edges and converting it to optical density (OD) units by the following equation:
OD=−LOG[% T/100]
The area under this OD unit curve is optical power.

For the polarizer embodiment in which the indices of the two polymer layers are matched in the non-stretched in-plane direction and not matched in the stretched direction, optical power is a measure proportional to the refractive index difference between the first polymer layer material and the second polymer layer material, in the stretch direction. Since the effective refractive index difference between the first polymer layer material and the second polymer layer material may not be easy to measure, optical power calculations are a convenient means to determine the relative birefringence between layers in multilayer optical films, provided the number of layer pairs, and materials used are known. Optical power is proportional to the number of optical layer pairs in a specific multilayer optical film, thus optical power of a specific film can be divided by the number of optical layer pairs to obtain an (average) optical power per optical layer pair. In many embodiments, the multilayer optical films have an optical power in a range from 1.2 to 2.0 per optical layer pair, or from 1.4 to 1.7 per optical layer pair. Thus, one illustrative multilayer optical film having 825 layers or about 411 layer pairs have an optical power in a range from 500 to 800, or from 600 to 700.

In some embodiments, a multilayer reflective polarizer 10 includes a stack of polymer layers with a Brewster angle (the angle at which reflectance of p-polarized light goes to zero) that is very large or nonexistent. In many embodiments, the multilayer reflective polarizer 10 has reflectivity for p-polarized light that decreases slowly with angle of incidence, is independent of angle of incidence, or increases with angle of incidence away from the normal. Commercially available forms of such multilayer reflective polarizers are marketed as Dual Brightness Enhanced Film (DBEF) by 3M, St. Paul, Minn.

The first and second optical layers and any optional non-optical layers of the multilayer optical film can be composed of polymers such as, for example, polyesters. Polyesters include carboxylate and glycol subunits and are generated by reactions of carboxylate monomer molecules with glycol monomer molecules. Each carboxylate monomer molecule has two or more carboxylic acid or ester functional groups and each glycol monomer molecule has two or more hydroxy functional groups. The carboxylate monomer molecules may all be the same or there may be two or more different types of molecules. The same applies to the glycol monomer molecules.

The term “polymer” will be understood to include homopolymers and copolymers, as well as polymers or copolymers that may be formed in a miscible blend. The properties of a polymer layer or film usually vary with the particular choice of monomer molecules. One example of a polyester useful in exemplary multilayered optical films is polyethylene naphthalate (PEN) which can be made, for example, by reactions of naphthalene dicarboxylic acid with ethylene glycol. Another example of a polyester useful in exemplary multilayered optical films is polyethylene terephthalate (PET) which can be made, for example, by reactions of terephthalic acid with ethylene glycol.

Suitable carboxylate monomer molecules for use in forming the carboxylate subunits of the polyester layers include, for example, 2,6-naphthalene dicarboxylic acid and isomers thereof; terephthalic acid; isophthalic acid; phthalic acid; azelaic acid; adipic acid; sebacic acid; norbornene dicarboxylic acid; bi-cyclooctane dicarboxylic acid; 1,6-cyclohexane dicarboxylic acid and isomers thereof, t-butyl isophthalic acid, tri-mellitic acid, sodium sulfonated isophthalic acid; 2,2′-biphenyl dicarboxylic acid and isomers thereof, and lower alkyl esters of these acids, such as methyl or ethyl esters. The term “lower alkyl” refers, in this context, to C₁-C₁₀ straight-chained or branched alkyl groups. Also included within the term “polyester” are polycarbonates which are derived from the reaction of glycol monomer molecules with esters of carbonic acid.

Suitable glycol monomer molecules for use in forming glycol subunits of the polyester layers include ethylene glycol; propylene glycol; 1,4-butanediol and isomers thereof, 1,6-hexanediol; neopentyl glycol; polyethylene glycol; diethylene glycol; tricyclodecanediol; 1,4-cyclohexanedimethanol and isomers thereof, norbornanediol; bicyclo-octanediol; trimethylol propane; pentaerythritol; 1,4-benzenedimethanol and isomers thereof, bisphenol A; 1,8-dihydroxy biphenyl and isomers thereof, and 1,3-bis(2-hydroxyethoxy)benzene.

As mentioned above, the first optical layers 12 can be orientable polymer layers, which may be made birefringent by, for example, stretching the first optical layers 12 in a desired direction or directions. The term “birefringent” means that the indices of refraction in orthogonal x, y, and z directions are not all the same. For films or layers in a film, a convenient choice of x, y, and z axes is where the x and y axes (in-plane axes) correspond to the length and width of the film or layer and the z axis (out-of-plane axis) corresponds to the thickness of the layer or film. In some embodiments, the x-axis refers to the transverse direction (TD) or cross-web direction, the y-axis refers to the machine direction (MD) or down-web direction, and the z-axis refers to the normal direction (ND) or thickness direction. In the embodiment illustrated in FIG. 1, the film 10 has several optical layers 12, 14 which are stacked one on top of another in the z-direction.

In many embodiments, the first optical layers 12 may be uniaxially-oriented, for example, by stretching (i.e., drawing) in a substantially single direction. A second orthogonal direction may be allowed to neck into some value less than its original length, as desired. In some exemplary embodiments, the first optical layers may be oriented or stretched (i.e., drawn) in a manner that departs from perfectly uniaxial draw but still results in a reflective polarizer that has a desired optical power. Such nearly uniaxial stretch may be referred to as “substantially uniaxial” stretch. The term “uniaxial” or “substantially uniaxial” stretch refers to a direction of stretching that substantially corresponds to either the x or y axis (an in-plane axis or direction) of the film 10. For the purposes of the present disclosure, the term “uniaxial stretch” shall be used to refer to both perfectly “uniaxial” and “substantially uniaxial” stretches. However, other designations of stretch directions may be chosen. In many embodiments, the reflective polarizer is drawn uniaxially or substantially uniaxially in the transverse direction (TD), while allowed to relax in the machine direction (MD) as well as the normal direction (ND). Suitable apparatuses that can be used to draw such exemplary embodiments of the present disclosure and definitions of uniaxial or substantially uniaxial stretching (drawing) that can be used to draw such exemplary embodiments of the present disclosure are described in U.S. Pat. No. 6,916,440, US2002/0190406, US2002/0180107, US2004/0099992 and US2004/0099993, the disclosures of which are hereby incorporated by reference herein. The phrase “consisting essentially of a uniaxial stretch” refers to stretching a film uniaxially in a first stretch direction and optionally, in a second stretch direction different than the first stretch direction, such that the stretching in second direction, if any, does not appreciably alter the birefringence.

In some embodiments, the film can be stretched in a second direction different than the first stretch direction, such that the stretching in second direction alters the birefringence but still results in a reflective polarizer that has a desired optical power, as would be understood by those skilled in the art. Stretching in the second direction can be performed simultaneously with the stretching in the first direction, or subsequent to the stretching in the first direction, as desired.

A birefringent, oriented layer typically exhibits a difference between the transmission and/or reflection of incident light rays having a plane of polarization parallel to the oriented direction (i.e., stretch direction) and light rays having a plane of polarization parallel to a transverse direction (i.e., a direction orthogonal to the stretch direction). For example, when an orientable polyester film is stretched along the x axis, the typical result is that nₓ≠n_{y}, where nₓ and n_{y} are the indices of refraction for light polarized in a plane parallel to the “x” and “y” axes, respectively. The degree of alteration in the index of refraction along the stretch direction will depend on factors such as the amount of stretching, the stretch rate, the temperature of the film during stretching, the thickness of the film, the variation in the film thickness, and the composition of the film. In many embodiments, the first optical layers 12 have an in-plane birefringence (e.g., the absolute value of nₓ−n_{y}) after orientation of 0.04 or greater at 632.8 nm, or about 0.05 or greater, or about 0.1 or greater, or about 0.2 or greater.

Polyethylene naphthalate (PEN) is an example of a useful material for forming the first optical layers 12 because it is highly birefringent after stretching. The refractive index of PEN for 632.8 nm light polarized in a plane parallel to the stretch direction can increase from about 1.62 to as high as about 1.87.

The birefringence of a particular polymeric material can be increased by increasing the molecular orientation. Many birefringent materials are crystalline or semicrystalline. The term “crystalline” will be used herein to refer to both crystalline and semicrystalline materials. PEN and other crystalline polyesters, such as polybutylene naphthalate (PBN), polyethylene terephthalate (PET) and polybutylene terephthalate (PBT) are examples of crystalline materials useful in the construction of birefringent film layers, such as is often the case for the first optical layers 12. In addition, some copolymers of PEN, PPN, PBN, PHN, PET, PPT, PHT and PBT are also crystalline or semicrystalline. The addition of a comonomer to PEN, PPN, PBN, PHN, PET, PPT, PHT, or PBT may enhance other properties of the material including, for example, adhesion to the second optical layers 14 or the non-optical layers and/or the lowering of the working temperature (i.e., the temperature for extrusion and/or stretching the film).

In some embodiments, the first optical layers 12 are made from a semicrystalline, birefringent copolyester which includes 25 to 100 mol % of a first carboxylate subunit and 0 to 75 mol %, of comonomer carboxylate subunits. The comonomer carboxylate subunits may be one or more of the subunits indicated hereinabove. In some embodiments, first carboxylate subunits include naphthalate or terephthalate. The first optical layers 12 are made from a semicrystalline, birefringent copolyester which includes 70 to 100 mol % of a first glycol subunit and 0 to 30 mol %, or 5 to 30 mol % of comonomer glycol subunits. The comonomer glycol subunits may be one or more of the subunits indicated hereinabove. In some embodiments, first glycol subunits are derived from C₂-C₈ diols. In other embodiments, first glycol subunits are derived from ethylene glycol, hexanediol, or 1,4-butanediol. Examples of films produced with 70 to 100 mol % of a first carboxylate subunit wherein the first carboxylate subunits include naphthalate or terephthalate are described in U.S. Pat. No. 6,352,761, incorporated by reference herein to the extent it is not inconsistent with the present disclosure. Examples of films produced with 25 to 70 mol % of a first carboxylate subunit wherein the first carboxylate subunits include naphthalate or terephthalate are described in U.S. Pat. No. 6,449,093, incorporated by reference herein to the extent it is not inconsistent with the present disclosure.

With the increasing addition of comonomer carboxylate and/or glycol subunits, the index of refraction in the orientation direction, typically the largest index of refraction, often decreases. Based on such an observation, this might lead to a conclusion that the birefringence of the first optical layers will be proportionately affected. However, it has been found that the index of refraction in the transverse direction also decreases with the addition of comonomer subunits. This results in substantial maintenance of the birefringence.

In many cases, a multilayered polymer film 10 may be formed using first optical layers 12 that are made from a coPEN which has the same in-plane birefringence for a given draw ratio (i.e., the ratio of the length of the film in the stretch direction after stretching and before stretching) as a similar multilayered polymer film formed using PEN for the first optical layers 12. The matching of birefringence values may be accomplished by the adjustment of processing parameters, such as the processing or stretch temperatures. Often coPEN optical layers have an index of refraction in the draw direction which is at least 0.02 units less than the index of refraction of the PEN optical layers in the draw direction. The birefringence is maintained because there is a decrease in the index of refraction in the non-draw direction.

In some embodiments of the multilayered polymer films, the first optical layers 12 are made from coPEN which has in-plane indices of refraction (i.e., nₓ and n_{y} ) that are 1.83 or less, or 1.80 or less, and which differ (i.e., |nₓ−n_{y}|) by 0.15 units or more, or 0.2 units or more, when measured using 632.8 nm light. PEN often has an in-plane index of refraction that is 1.84 or higher and the difference between the in-plane indices of refraction is about 0.22 to 0.24 or more when measured using 632.8 nm light. The in-plane refractive index differences, or birefringence, of the first optical layers, whether they be PEN or coPEN, may be reduced to less than 0.2 to improve properties, such as interlayer adhesion.

The second optical layers 14 may be made from a variety of polymers. Examples of suitable polymers include vinyl polymers and copolymers made from monomers such as vinyl naphthalenes, styrene, maleic anhydride, acrylates, and methacrylates. Examples of such polymers include polyacrylates, polymethacrylates, such as poly(methyl methacrylate) (PMMA), and isotactic or syndiotactic polystyrene. Other polymers include condensation polymers such as polysulfones, polyamides, polyurethanes, polyamic acids, and polyimides. In addition, the second optical layers 14 may be formed from polymers and copolymers such as polyesters and polycarbonates. The second optical layers 14 will be exemplified below by copolymers of polyesters. However, it will be understood that the other polymers described above may also be used. The same considerations with respect to optical properties for the copolyesters, as described below, will also typically be applicable for the other polymers and copolymers.

In some embodiments, the second optical layers 14 are orientable. However, more typically the second optical layers 14 are not oriented under the processing conditions used to orient the first optical layers 12. In the latter case, the second optical layers 14 typically retain a relatively isotropic index of refraction, even when stretched. In many embodiments, the second optical layers 14 have a birefringence of less than about 0.04, or less than about 0.02 at 632.8 nm. However, some exemplary embodiments may utilize birefringent optical layers.

Examples of suitable materials for the second optical layers 14 are copolymers of PEN, PPN, PBN, PHN, PET, PPT, PHT, or PBT. Typically, these copolymers include carboxylate subunits which are 20 to 100 mol % second carboxylate subunits, such as naphthalate (for coPEN or coPBN) or terephthalate (for coPET or coPBT) subunits, and 0 to 80 mol % second comonomer carboxylate subunits. The copolymers also include glycol subunits which are 40 to 100 mol % second glycol subunits, such as ethylene (for coPEN or coPET) or butylene (for coPBN or coPBT), and 0 to 60 mol % second comonomer glycol subunits. At least about 10 mol % of the combined carboxylate and glycol subunits are second comonomer carboxylate or glycol subunits.

One example of a polyester for use in second optical layers 14 is a low cost coPEN. One currently used coPEN has carboxylate subunits which are about 70 mol % naphthalate and about 30 mol % isophthalate. Low cost coPEN replaces some or all of the isophthalate subunits with terephthalate subunits. The cost of this polymer is reduced as dimethyl isophthalate, the typical source for the isophthalate subunits, currently costs considerably more than dimethyl terephthalate, a source for the terephthalate subunits. Furthermore, coPEN with terephthalate subunits tends to have greater thermal stability than coPEN with isophthalate subunits.

However, substitution of terephthalate for isophthalate may increase the birefringence of the coPEN layer; so a combination of terephthalate and isophthalate may be desired. Low cost coPEN typically has carboxylate subunits in which 20 to 80 mol % of the carboxylate subunits are naphthalate, 10 to 60 mol % are terephthalate, and 0 to 50 mol % are isophthalate subunits. In some embodiments, 20 to 60% mol % of the carboxylate subunits hare terephthalate and 0 to 20 mol % are isophthalate. In other embodiments, 50 to 70 mol % of the carboxylate subunits are naphthalate, 20 to 50 mol % are terephthalate, and 0 to 10 mol % are isophthalate subunits.

Because coPENs may be slightly birefringent and orient when stretched, it sometimes may be desirable to produce a polyester composition for use with second optical layers 14 in which this birefringence is reduced. Low birefringent coPENs may be synthesized by the addition of comonomer materials. Examples of suitable birefringent-reducing comonomer materials for use as diol subunits are derived from 1,6-hexanediol, trimethylol propane, and neopentyl glycol. Examples of suitable birefringent-reducing comonomer materials for use as carboxylate subunits are derived from t-butyl-isophthalic acid, phthalic acid, and lower alkyl esters thereof.

In some embodiments, birefringent-reducing comonomer materials are derived from t-butyl-isophthalic acid, lower alkyl esters thereof, and 1,6-hexanediol. In other embodiments, comonomer materials are trimethylol propane and pentaerythritol which may also act as branching agents. The comonomers may be distributed randomly in the coPEN polyester or they may form one or more blocks in a block copolymer.

Examples of low birefringent coPEN include glycol subunits which are derived from 70-100 mol % C₂-C₄ diols and about 0-30 mol % comonomer diol subunits derived from 1,6-hexanediol or isomers thereof, trimethylol propane, or neopentyl glycol and carboxylate subunits which are 20 to 100 mol % naphthalate, 0 to 80 mol % terephthalate or isophthalate subunits or mixtures thereof, and 0 to 30 mol % of comonomer carboxylate subunits derived from phthalic acid, t-butyl-isophthalic acid, or lower alkyl esters thereof. In some embodiments, the low birefringence coPEN has at least 0.5 to 50 mol % of the combined carboxylate and glycol subunits which are comonomer carboxylate or glycol subunits.

The addition of comonomer subunits derived from compounds with three or more carboxylate, ester, or hydroxy functionalities may also decrease the birefringence of the copolyester of the second layers. These compounds act as branching agents to form branches or crosslinks with other polymer molecules. In some embodiments of the invention, the copolyester of the second layer includes 0.01 to 5 mol %, or 0.1 to 2.5 mol %, of these branching agents.

One particular polymer has glycol subunits that are derived from 70 to 99 mol % C₂-C₄ diols and about 1 to 30 mol % comonomer subunits derived from 1,6-hexanediol and carboxylate subunits that are 5 to 99 mol % naphthalate, 1 to 95 mol % terephthalate, isophthalate, or mixtures thereof, 0 and to 30 mol % comonomer carboxylate subunits derived from one or more of phthalic acid, t-butyl-isophthalic acid, or lower alkyl esters thereof. In some embodiments, at least 0.01 to 2.5 mol % of the combined carboxylate and glycol subunits of this copolyester are branching agents.

In many embodiments, the optical films are thin. Suitable films include films of varying thickness, but particularly films less than 15 mils (about 380 micrometers) thick, or less than 10 mils (about 250 micrometers) thick, or less than 7 mils (about 180 micrometers) thick.

In addition to the first and second layers, the multilayer optical film optionally includes one or more additional optical and/or non-optical layers such as, for example, one or more interior non-optical layers, such as, for example, protective boundary layers between packets of optical layers. Non-optical layers can be used to give the multilayer film structure or to protect it from harm or damage during or after processing. The non-optical layers may be of any appropriate material and can be the same as one of the materials used in the optical stack. Of course, it is important that the material chosen for the additional layers not have optical properties deleterious to those of the optical stack. In many embodiments, the polymers of the first optical layers, the second optical layers, and the additional layers are chosen to have similar Theological properties (e.g., melt viscosities) so that they can be co-extruded without flow disturbances. In some embodiments, the second optical layers, and other additional layers have a glass transition temperature, T_{g}, that can be either about, below or no greater than about 40° C. above the glass transition temperature of the first optical layers. In some embodiments, the glass transition temperature of the second optical layers, and additional layers is below the glass transition temperature of the first optical layers.

The thickness of the additional layers can be at least four times, or at least 10 times, and can be at least 100 times, the thickness of at least one of the individual first and second optical layers. The thickness of the additional layers can be selected to make a multilayer optical film having a particular thickness.

While the multilayer optical stacks, as described above, can provide significant and desirable optical properties, other properties, which may be mechanical, optical, or chemical, are difficult to provide in the optical stack itself without degrading the performance of the optical stack. Such properties may be provided by including one or more layers with the optical stack that provide these properties while not contributing to the primary optical function of the optical stack itself. Since these layers, e.g., coatings, are typically provided on the major surfaces of the optical stack, they are often known as “skin layers” 18. The thickness of the skin layer 18 can vary depending upon the application. In many embodiments, the skin layer 18 is from 0.01 to 10 mils (about 2 to 250 micrometers) thick, or from 0.5 to 8 mils (about 12 to 200 micrometers) thick, or from 1 to 7 mils (about 25 to 180 micrometers) thick.

Various methods may be used for forming exemplary optical films of the present disclosure. As stated above, optical films can take on various configurations, and thus the methods vary depending upon the particular configuration of the final embodiment.

FIG. 2 shows a schematic plan view of an illustrative system for forming a reflective polarizer in accordance with the disclosure. A first polymer material 100 and a second polymer material 102, as described above, are heated above their melting and/or glass transition temperatures and fed into a multilayer feedblock 104. In many embodiments, melting and initial feeding is accomplished using an extruder for each material. For example, first polymer material 100 can be fed into an extruder 101 while second polymer material 102 can be fed into an extruder 103. Exiting from the feedblock 104 is a multilayer flow stream 105. In some embodiments, a layer multiplier 106 splits the multilayer flow stream, and then redirects and “stacks” one stream atop the second to multiply the number of layers extruded. An asymmetric multiplier, when used with extrusion equipment that introduces layer thickness deviations throughout the stack, may broaden the distribution of layer thicknesses so as to enable the multilayer film to have polymeric optical layer pairs corresponding to a desired portion of the visible spectrum of light, and provide a desired layer thickness gradient, if desired. In some embodiments, skin layers 111 are introduced into the multilayer optical film by feeding skin layer resin 108 to a skin layer feedblock 110.

The feedblock 110 feeds a film extrusion die 112. Feedblocks useful in the manufacture of the present invention are described in, for example, U.S. Pat. No. 3,773,882 (Schrenk) and U.S. Pat. No. 3,884,606 (Schrenk), the contents of which are incorporated by reference herein to the extent it is not inconsistent with the present disclosure. In many many embodiments, skin layers 111 flow on the upper and lower surfaces of the film as it goes through the feedblock and die. These layers can serve to dissipate the large stress gradient found near the wall, leading to smoother extrusion of the optical layers. The skin material can be the same material as one of the optical layers or be a different material. An extrudate film 116 leaving the die is typically in a melt form. In some exemplary embodiments, one or both of the skin layers 111 may be removable from the remainder of the film stack.

A coating layer (not shown) can be disposed on the film 116 exiting the film extrusion die 112, if desired. The coating layer is selected so that it remains intact following stretching in a tenter oven 120, which can depend on the amount of stretching or draw ratio achieved in the tenter oven 120 . The film 116 is then oriented by stretching at ratios determined by the desired optical and mechanical properties. In many embodiments, transverse stretching is done in a tenter oven 120. The film can then be collected on windup roll 124, if desired. In many embodiments, the film is not heat set following stretching.

Coating layers often exhibit elongation limits that, when exceeded, causes the coating to, for example, crack, craze, delaminate, lose a physical property, or otherwise fail. Thus, stretching a film at a 5:1 ratio or less (i.e., 500% elongation or less), a 4.5:1 ratio or less (i.e., 450% elongation or less), a 4:1 ratio or less (i.e., 400% elongation or less) allows for a broader range of coatings that can be applied to an unstretched film than stretching that film at, for example, a 6:1 ratio (i.e., 600% elongation). Some examples of coating layers that can exhibit elongation limitations up to 400%, 450%, or 500% include some primer and anti-static materials.

The reflective polarizers constructed according to the present disclosure are stretched or drawn in a manner that consists essentially of a uniaxial stretch (e.g., along the machine direction or along the direction substantially orthogonal to the machine direction). As described above, the phrase “consisting essentially of a uniaxial stretch” refers to a film that has been stretched in a first stretch direction and if stretched in a second stretch direction, different than the first stretch direction, does not produce appreciable birefringence with the second stretch direction. In many embodiments, the reflective polarizer is drawn uniaxially in the transverse direction (TD), while allowed to relax in the machine direction (MD) as well as the normal direction (ND). Suitable apparatuses that can be used to draw such exemplary embodiments of the present disclosure and definitions of uniaxial or substantially uniaxial stretching (drawing) that can be used to draw such exemplary embodiments of the present disclosure are described in U.S. Pat. Nos. 6,916,440, US 2002/0190406, US 2002/0180107,US2004/0099992 and US2004/0099993, the disclosures of which are hereby incorporated by reference herein.

Exemplary multi-layer films of the present disclosure include optical layer pairs formed from polyester molecular units, as described above that are stretched uniaxially at a ratio of less than 5:1 or from 2 to below 5:1 or from 3-4.5:1. Exemplary multi-layer films of the present disclosure may be stretched at a temperature that is about or approximately equal to a higher of the glass transition temperatures of the polymers of the first and second optical layers. In many cases, the lowest temperature at which a polymer film can be effectively stretched, for the purpose of orientation, is its glass transition temperature, Tg. Below Tg, many polymers are glassy, and will break at a very low stretch ratio, rather than stretch. It is understood in the art that the glass transition is a non-equilibrium phenomenon, and the precise value of Tg for any polymer specimen will depend on the method of testing and the rate of change imposed on the polymer specimen by the test. For instance, if Tg is measured by differential scanning calorimetry (DSC), it will depend on the temperature scan rate; and if Tgis measured by dynamic mechanical analysis, it will depend on the vibrational frequency employed. Therefore, any quoted value for Tg is an approximation. Thus, the lower bound for stretching temperature in the present invention is said to be approximately (or “about”) Tg, or about Tg, of one of the polymer layers.

In some exemplary embodiments, exemplary multi-layer films of the present disclosure may be stretched at temperatures that are about or approximately equal to a higher of the glass transition temperatures of the polymers of the first and second optical layers, or from 5 to 40 degrees centigrade, or from 5 to 30 degrees centigrade, or from 5 to 25 degrees centigrade above the glass transition temperature of the polyester with the higher glass transition temperature, i.e., the higher of: a glass transition temperature of the polymer of the first optical layers and a second glass transition temperature of the polymer of the second optical layers.

Further, exemplary multi-layer films of the present disclosure can provide reflective polarizers having a number of product and processing advantages as compared to similar films stretched at ratios greater than 5:1, for a given optical power. For example, these “low-draw” multi-layer polyester polarizer films can exhibit: surprisingly improved draw and/or thickness uniformity in the down-web (MD) and/or cross-web (TD) direction; improved delamination resistance; improved film dimensional stability; and/or an expanded drawing temperature processing window, as compared to a similar film stretched at a ratio greater than 5:1 or 6:1.

### EXAMPLES

### Example 1

Several cast web precursors for multilayer optical film polarizers were produced on a commercial-scale film line. Two polymers were used for the optical layers. The first polymer (first optical layers) was polyethylene naphthalate (PEN) homopolymer (100 mol % naphthalene dicarboxylate with 100 mol % ethylene glycol) having a Tgof 121-123 degrees centigrade. The second polymer (second optical layers) was a first polyethylene naphthalate copolymer (coPEN) having 55 mol % naphthalate and 45 mol % terephthalate as carboxylates and 95.8 mol % ethylene glycol, 4 mol % hexane diol, and 0.2 mol % trimethylol propane as glycols, having a Tgof 94 degrees centigrade. The polymer used for the skin layers was a second coPEN having 75 mol % naphthalate and 25 mol % terephthalate as carboxylates and 95.8 mol % ethylene glycol, 4 mol % hexane diol, and 0.2 mol % trimethylol propane as glycols, having a Tg of 101 degrees centigrade. These polyesters can be formed, for example, as described in U.S. Pat. No. 6,352,761.

The PEN and first coPEN polymers were fed from separate extruders to a multilayer coextrusion feedblock, in which they were assembled into a packet of 275 alternating optical layers, plus a thicker protective boundary layer of the coPEN, on each side, for a total of 277 layers. From the feedblock, the multilayer melt was conveyed through one three-fold layer multiplier, resulting in a construction having 829 layers. The skin layers of the second coPEN were added to the construction in a manifold specific to that purpose, resulting in a final construction having 831 layers. The multilayer melt was then cast through a film die onto a chill roll, in the conventional manner for polyester films, upon which it was quenched. The speed of the casting wheel was adjusted to provide cast webs of four different thicknesses of approximately 580, 530, 480, and 430 microns. All other conditions of the extrusion, including throughput rates, temperatures, and die bolt settings, were maintained constant throughout the production of the four rolls of cast web, and were typical of conditions well known in the art for the extrusion of PENs and coPENs. Each of the four cast webs was wound up without any further processing.

The cast web rolls were cut into 90 mm square specimens, and these specimens were stretched using a laboratory batch film stretcher (KARO IV, Brueckner Maschinenbau GmbH, Siegsdorf, Germany). Except for the temperature at which the stretching was done and the stretch ratio employed, each specimen was handled identically. The specimen was loaded, gripped, and preheated to the desired stretch temperature. The specimen was then stretched in one direction only, at a constant rate of 100% sec, to the desired nominal stretch ratio. Prior to loading into the stretcher, each specimen was provided with fiduciary marks at a fixed spacing. Following removal of each stretched specimen from the stretcher, the displacement of the fiduciary marks was measured, and the true stretch ratio was calculated by comparing this spacing to the pre-stretched spacing.

Specimens were stretched (i.e., drawn) at eight different temperatures: 126°C., 130°C., 134°C., 138°C., 142°C., 145°C., 149°C., and 152°C. Many different stretch ratios in the range from 3.6 to 6.6 were used. It was found that for nominal stretch ratios of about 5.0 and above, the real stretch ratios (i.e., real draw ratios) obtained were, on average, about 0.4 units smaller; for nominal stretch ratios of about 4.0 to about 5.0, the real stretch ratios obtained were, on average, about 0.3 units smaller; and, for nominal stretch ratios below about 4.0, the real stretch ratios obtained were, on average, about 0.2 units smaller. In order to measure the optical power on the stretched specimens, the individual layer thicknesses in the stretched films must be in the appropriate optical range, so that the entire reflection band is within the range of the instrument and can be measured. Thus, when the target real stretch ratio was above about 5.0, the 580 micron cast web was used; when the target real stretch ratio was about 4.7 to about 5.0, the 530 micron cast web was used; when the target real stretch ratio was about 4.4 to about 4.6, the 480 micron cast web was used; and, when the target real stretch ratio was below about 4.4, the 430 micron cast web was used. Multiple specimens were tested at each combination of stretch temperature and nominal stretch ratio. Specimens which broke during stretching, or which were visibly non-homogeneous in thickness after stretching, were discarded. All other stretched specimens were measured for optical power. If, upon inspecting the test results, it was determined that the band edge for a specimen was outside the range of detection for the instrument, the data for that specimen was also discarded.

In this way, a large number of data points were obtained, including at least one at every discrete 0.1-unit real ratio value from 3.7 to 6.6, except for 6.2 and 6.3. Because of film breakage and non-uniformity, not all stretch ratios are represented at each stretch temperature. The higher stretch ratios tended to be inaccessible at the lower stretch temperature due to breakage, and the lower stretch ratios tended to be inaccessible at the higher stretch temperatures due to non-uniformity of stretching. The data is listed in Table 1.

TABLE 1

| Stretching Temperature | Real Stretch | |
|---|---|---|
| (C.) | Ratio | Optical Power |
| 126 | 3.8 | 403 |
| 126 | 3.9 | 524 |
| 126 | 3.9 | 525 |
| 126 | 4.1 | 610 |
| 126 | 4.1 | 614 |
| 126 | 4.1 | 618 |
| 126 | 4.2 | 666 |
| 126 | 4.3 | 676 |
| 126 | 4.3 | 704 |
| 126 | 4.5 | 718 |
| 126 | 4.6 | 726 |
| 130 | 3.7 | 439 |
| 130 | 3.7 | 474 |
| 130 | 3.8 | 542 |
| 130 | 4.1 | 576 |
| 130 | 4.1 | 610 |
| 130 | 4.2 | 623 |
| 130 | 4.3 | 616 |
| 130 | 4.3 | 667 |
| 130 | 4.4 | 706 |
| 134 | 4.1 | 532 |
| 134 | 4.2 | 614 |
| 134 | 4.2 | 628 |
| 134 | 4.3 | 556 |
| 134 | 4.5 | 672 |
| 134 | 4.5 | 672 |
| 134 | 4.6 | 662 |
| 134 | 4.6 | 749 |
| 134 | 4.7 | 751 |
| 134 | 4.8 | 748 |
| 138 | 4.0 | 506 |
| 138 | 4.1 | 530 |
| 138 | 4.2 | 523 |
| 138 | 4.2 | 537 |
| 138 | 4.2 | 565 |
| 138 | 4.4 | 610 |
| 138 | 4.5 | 639 |
| 138 | 4.6 | 714 |
| 138 | 4.9 | 748 |
| 138 | 5.0 | 804 |
| 138 | 5.1 | 814 |
| 138 | 5.2 | 815 |
| 138 | 5.2 | 833 |
| 138 | 5.7 | 903 |
| 138 | 5.8 | 929 |
| 138 | 5.9 | 913 |
| 142 | 4.2 | 529 |
| 142 | 4.3 | 450 |
| 142 | 4.3 | 470 |
| 142 | 5.0 | 681 |
| 142 | 5.0 | 696 |
| 142 | 5.1 | 719 |
| 142 | 5.4 | 731 |
| 142 | 5.4 | 755 |
| 142 | 5.4 | 757 |
| 142 | 5.5 | 765 |
| 142 | 5.9 | 847 |
| 142 | 5.9 | 863 |
| 142 | 6.0 | 868 |
| 142 | 6.0 | 887 |
| 145 | 4.3 | 516 |
| 145 | 4.4 | 593 |
| 145 | 4.6 | 630 |
| 145 | 4.7 | 615 |
| 145 | 4.7 | 620 |
| 145 | 5.0 | 654 |
| 145 | 5.0 | 680 |
| 145 | 5.0 | 706 |
| 145 | 5.1 | 667 |
| 145 | 5.1 | 682 |
| 145 | 5.5 | 811 |
| 145 | 5.6 | 834 |
| 145 | 5.7 | 845 |
| 149 | 5.0 | 385 |
| 149 | 5.1 | 298 |
| 149 | 5.2 | 205 |
| 149 | 5.4 | 171 |
| 149 | 5.5 | 189 |
| 149 | 5.7 | 299 |
| 149 | 6.4 | 730 |
| 149 | 6.6 | 595 |
| 152 | 4.5 | 330 |
| 152 | 4.5 | 377 |
| 152 | 4.8 | 373 |
| 152 | 5.1 | 467 |
| 152 | 5.2 | 578 |
| 152 | 5.3 | 539 |
| 152 | 5.6 | 527 |
| 152 | 5.7 | 594 |
| 152 | 6.1 | 650 |
| 152 | 6.5 | 636 |

The data obtained(optical power as a function of stretch temperature and real stretch ratio) was analyzed as follows. For each temperature, a linear regression was performed, with optical power [OP] as the dependent variable and real stretch ratio [RSR] as the independent variable.
[OP]=m[RSR]+b Eqn. 1
Each data set showed a good linear fit. Comparing the eight data regressions, it was observed that the m and b constants so obtained varied smoothly, but non-linearly, with the stretch temperature. Thus, the parameter m was linearly regressed as a function of the inverse of the stretch temperature (T).
m=m′(1/T)+b″ Eqn. 2
In addition, the inverse of the parameter b was linearly regressed as a function of the inverse of the stretch temperature.
(1/b)=m″(1/T)+b″ Eqn. 3
Both of these regressions showed good fit. Substitution of Equation 2 and Equation 3 into Equation 1 yields an equation for the optical power, as a function of both real stretch ratio and stretch temperature, of the form.
[OP]=(m′(1/T)+b′)[RSR]+1/(m″(1/T)+b″) Eqn. 4
The values for the constants obtained by the methods described above were

m′=145422.0

b′=−798.9230

m″=1.344378

b″=−0.01178888

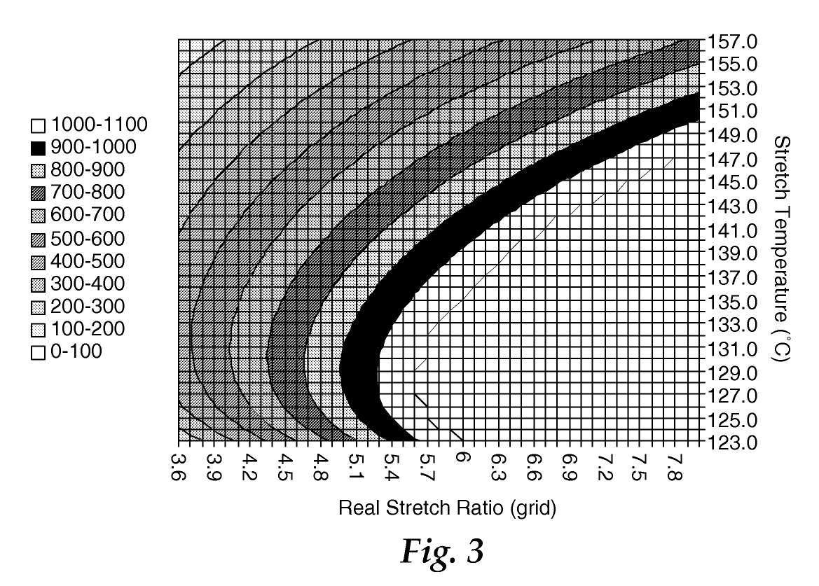

Equation 4 was graphed in the form of a contour plot, as shown in FIG. 3. In FIG. 3, the horizontal axis is the real stretch ratio, and the vertical axis is the stretch temperature. The contours are curves of equal optical power, with higher optical power contours tending to the right side of the figure.

It has been elsewhere observed for this PEN-based multilayer optical film system that when the optical power rises above about 700 to 800, the film sometimes can become prone to delamination (exfoliation) of the layer structure. Thus, a useful film of highest optical power can be found somewhere near the band between the contours for optical power of 600, 700 and 800. Each contour in FIG. 3 has a minimum value in real stretch ratio. It was observed that the stretch temperature corresponding to that minimum is a critical temperature. For that stretch ratio, at temperatures lower than this critical temperature, the optical clarity of the film was observed to degrade compared to films made at higher stretch temperatures. Thus, the most useful films are those made at higher stretch temperatures (above the bend-over points of the contours in FIG. 3).

Turning attention to the band between the 600 and 700 contours in FIG. 3, it can be seen that at a real stretch ratio of 5.9 to 6.2, stretch ratios typical in the art for PEN-based multilayer optical films, the process window in stretch temperature is small (the band is narrow). Surprisingly, at the unexpectedly low real stretch ratio of about 4.3, not only is the same high optical power accessible, but the process window in stretch temperature is also exceptionally large (the band is wide). This is so even if only the portion of the band higher than the critical temperature is regarded as optimal, for the reasons cited in the paragraph above.

### Example 2A-2D

Cast web was prepared on a film line in a manner similar to that in Example 1. Rather than being wound up for off-line experimentation, the film was conveyed to the tenter, for stretching in the transverse direction. For Examples 2C and 2D, the film was first conveyed to a coating station, where it was coated prior to entry into the tenter. Films of Examples 2A and 2B were uncoated.

The film coating was prepared as follows. Rhoplex 3208 (Rohm & Haas Co., Philadelphia, Pa.), an acrylic emulsion polymer with melamine crosslinker functionality, was added to deionized water to make a mixture having 8 wt % coating solids content. Para Toluene Sulfonic Acid, or PTSA (Sigma-Aldrich, Milwaukee, Wis.), was neutralized by titration to NH₄-PTSA. A 10 wt % solution in deionized water was obtained. 0.5 g of this solution was added to each 50 g of the coating mixture, to serve as a crosslinking catalyst. Tergitol TMN6 (Union Carbide Corp., a subsidiary of the Dow Chemical Co., Midland, Mich.), a non-ionic branched secondary alcohol ethoxylate surfactant, was also obtained at a 10 wt % loading in deionized water. This was also added to the coating mixture at 0.5 g per 50 g of the coating mixture.

Because this coating is a primer for adhesion of subsequent coatings or laminations to the multilayer optical film, it is preferred to be continuous for mechanical reasons and very clear for optical reasons. Typically, the break-up of a coating during film stretching is accompanied by the generation of haze, so the two requirements are often linked, in practice.

For Examples 2A and 2C, the films were tenter-stretched in the transverse direction at a temperature of about 150° C. to a stretch ratio of about 6.0. For Examples 2B and 2D, the films were tenter-stretched in the transverse direction at a temperature of about 138° C. to a stretch ratio of 4.5.

Haze and Clarity were measured using a BYK-Gardner Haze Gard Plus (BYK-Gardner U.S.A., Columbia, Md.) according to the manufacturer's directions on the four films. Table 2 contains these test results.

TABLE 2

| Example No. | Coated | Stretch Ratio | Haze | Clarity |
|---|---|---|---|---|
| 2A | No | 6.0 | 1.78% | 98.8% |
| 2B | No | 4.5 | 2.41% | 99.2% |
| 2C | Yes | 6.0 | 58.1% | 24.8% |
| 2D | Yes | 4.5 | 0.94% | 99.6% |

The data for Example 2D showed that the coating, when applied pre-tenter and stretched at the lower temperature and stretch ratio, actually improved the optics of the film. The data of Example 2C, however, show that at the higher stretch temperature and stretch ratio, the coating had broken up, resulting in a hazy film lacking clarity. Thus, stretching film at surprisingly low stretch temperatures and stretch ratios, enables the pre-tenter application of certain coatings which cannot be successfully pre-tenter coated at the traditional film stretching conditions.

### Example 3

Cast web for multilayer optical film polarizers were produced on a commercial-scale film line. Two polymers were used for the optical layers. The first polymer (first optical layers) was polyethylene naphthalate (PEN) homopolymer (100 mol % naphthalene dicarboxylate with 100 mol % ethylene glycol) having a Tgof 121-123 degrees centigrade. The second polymer (second optical layers) was a first polyethylene naphthalate copolymer (coPEN) having 55 mol % naphthalate and 45 mol % terephthalate as carboxylates and 95.8 mol % ethylene glycol, 4 mol % hexane diol, and 0.2 mol % trimethylol propane as glycols, having a Tgof 94 degrees centigrade. The polymer used for the skin layers was a second coPEN having 75 mol % naphthalate and 25 mol % terephthalate as carboxylates and 95.8 mol % ethylene glycol, 4 mol % hexane diol, and 0.2 mol % trimethylol propane as glycols, having a Tgof 101 degrees centigrade. These polyesters can be formed, for example, as described in U.S. Pat. No. 6,352,761.

The PEN and first coPEN polymers were fed from separate extruders to a multilayer coextrusion feedblock, in which they were assembled into a packet of 275 alternating optical layers, plus a thicker protective boundary layer of the coPEN, on each side, for a total of 277 layers. From the feedblock, the multilayer melt was conveyed through one three-fold layer multiplier, resulting in a construction having 829 layers. The skin layers of the second coPEN were added to the construction in a manifold specific to that purpose, resulting in a final construction having 831 layers. The multilayer melt was then cast through a film die onto a chill roll, in the conventional manner for polyester films, upon which it was quenched. The speed of the casting wheel was adjusted to provide cast webs of desired optical thicknesses. Other conditions of the extrusion, including throughput rates, and temperatures were maintained constant throughout the production of the cast web, and were typical of conditions well known in the art for the extrusion of PENs and coPENs.

The cast web was then stretched commercial scale linear tenter at temperatures similar to those specified in Example 2. The samples were drawn to two levels of magnitude, 6.5:1 and 4.4:1. Stretch temperatures were adjusted within a range of 143 to 150 degrees centigrade and cast x-web thickness profile was adjusted by typical means known to the art such that both draw ratio ranges achieved equal gain and flattest possible x-web finished thickness given the equipment's capability at the time.

Capacitance film thickness gauges common to the art of film making were utilized to provide finished film thickness and transverse direction draw ratio statistics for 3 given down web lanes and one cross web lane. Film thickness uniformity for 4.4:1 draw ratio were superior to the film thickness uniformity for 6.5:1 draw ratio. The transverse direction (TD) thickness coefficient of variation (COV) is similar (see Table 3) but the 4.4:1 film has much smoother transitions and would likely have better performance in relation to color shifts and color uniformity due to abrupt changes in optical thickness of the 6.5:1 draw ratio film. Table 3 below shows the measured coefficient of variation in the machine direction, transverse directions.

TABLE 3

| | 54″ Wide Finished Web Lane Statistics | | | | |
|---|---|---|---|---|---|
| | Coefficient of | Coefficient of | Coefficient of | | |
| | Variation in | Variation in | Variation in | Coefficient of | Coefficient of |
| | Machine | Machine | Machine | Variation in | Variation in |
| | Direction at 7″ | Direction at 27″ | Direction at 47″ | Transverse | Transverse |
| | Transverse | Transverse | Transverse | Direction | Direction |
| | position | position | position | thickness | Draw Ratio |
| 6.5:1 Draw Ratio | 7.1% | 7.3% | 8.3% | 7.0% | 12.9% |
| 4.4:1 Draw Ratio | 3.0% | 2.6% | 3.7% | 6.8% | 7.0% |

All references and publications cited herein are expressly incorporated herein by reference in their entirety into this disclosure. Illustrative embodiments of this disclosure are discussed and reference has been made to possible variations within the scope of this disclosure. These and other variations and modifications in the disclosure will be apparent to those skilled in the art without departing from the scope of this disclosure, and it should be understood that this disclosure is not limited to the illustrative embodiments set forth herein. Accordingly, the disclosure is to be limited only by the claims provided below.

1. A method of forming a multilayer reflective polarizer comprising:
providing a multilayer polymer film having a plurality of alternating polymeric optical layer pairs, each optical layer pair comprising a first polymer layer comprising a first polyester material having a first glass transition temperature and a second polymer layer comprising a second polyester material having a second glass transition temperature, the second polymer layer having a different polymer composition than the first polymer layer;
heating the multilayer polymer film to a temperature from about the higher of the first and second polymer layer glass transition temperatures to about 40 degrees centigrade greater than the higher of the first and second polymer layer glass transition temperatures than to form a heated multilayer film; and
stretching the heated multilayer polymer film in an in-plane direction to a dimension less than five times that direction's unstretched dimension to form a multilayer reflective polarizer, wherein the stretching step consists essentially of a uniaxial stretch.

2. A method according to claim 1 wherein providing step comprises providing a first polymer layer and a second polymer layer, each first polymer layer comprising polyethylene naphthalate or a copolymer thereof, the second polymer layer comprising polyethylene naphthalate or a copolymer thereof.

3. A method according to claim 1 wherein providing step comprises providing a first polymer layer and a second polymer layer, each first polymer layer comprising polyethylene terephthalate or a copolymer thereof, the second polymer layer comprising polyethylene terephthalate or a copolymer thereof.

4. A method according to claim 1 wherein the stretching step comprises stretching the heated multilayer polymer film in an in-plane direction to obtain a multilayer reflective polarizer having an optical power in a range from 1.2 to 2.0 per optical layer pair.

5. A method according to claim 1 wherein the providing step comprises extruding a multilayer polymer film having alternating first polymer layers and second polymers layers.

6. A method according to claim 1 wherein the stretching step comprises stretching the heated multilayer polymer film in an in-plane direction to a dimension in a range from two to five times that direction's unstretched dimension to form a multilayer reflective polarizer.

7. A method according to claim 1 wherein the stretching step comprises stretching the heated multilayer polymer film in an in-plane direction to a dimension in a range from 3.5 to 4.5 times that direction's unstretched dimension to form a multilayer reflective polarizer.

8. A method according to claim 2 wherein the providing step comprises providing a multilayer polymer film having alternating first polyethylene naphthalate homopolymer layers and second polyethylene naphthalate copolymer layers.

9. A method of forming a multilayer reflective polarizer comprising:
providing a multilayer polymer film having a plurality of alternating polymeric optical layer pairs, each optical layer pair comprising a first polymer layer comprising a first polyester material having a first glass transition temperature and a second polymer layer comprising a second polyester material having a second glass transition temperature, the second polymer layer having a different polymer composition than the first polymer layer;
heating the multilayer polymer film to a temperature from about the higher of the first and second polymer layer glass transition temperatures to about 40 degrees centigrade greater than the higher of the first and second polymer layer glass transition temperatures than to form a heated multilayer film; and
stretching the heated multilayer polymer film in an in-plane direction to form a multilayer reflective polarizer having an optical power in a range from 1.2 to 2.0 per optical layer pair, wherein the stretching step consists essentially of a uniaxial stretch.

10. A method according to claim 9 wherein providing step comprises providing a first polymer layer and a second polymer layer, each first polymer layer comprising polyethylene naphthalate or a copolymer thereof, the second polymer layer comprising polyethylene naphthalate or a copolymer thereof.

11. A method according to claim 9 wherein providing step comprises providing a first polymer layer and a second polymer layer, each first polymer layer comprising polyethylene terephthalate or a copolymer thereof, the second polymer layer comprising polyethylene terephthalate or a copolymer thereof.

12. A method according to claim 9 wherein the stretching step comprises stretching the heated multilayer polymer film in an in-plane direction to a dimension less than five times that direction's unstretched dimension to obtain a multilayer reflective polarizer.

13. A method according to claim 9 wherein the stretching step comprises stretching the heated multilayer polymer film in an in-plane direction to a dimension in a range from two to five times that direction's unstretched dimension to form a multilayer reflective polarizer.

14. A method according to claim 9 wherein the stretching step comprises stretching the heated multilayer polymer film in an in-plane direction to a dimension in a range from 3.5 to 4.5 times that direction's unstretched dimension to form a multilayer reflective polarizer.

15. A method according to claim 9 wherein the stretching step comprises stretching the heated multilayer polymer film in an in-plane direction form a multilayer reflective polarizer having an optical power in a range from 1.4 to 1.7 per optical layer pair.

16. A method according to claim 9 wherein the providing step comprises providing a multilayer polymer film having alternating first polyethylene naphthalate homopolymer layers and second polyethylene naphthalate copolymer layers.

17. A method of forming a multilayer reflective polarizer comprising:
providing a multilayer polymer film having a plurality of alternating polymeric optical layer pairs, each optical layer pair comprising a first polymer layer comprising a first polyester material having a first glass transition temperature and a second polymer layer comprising a second polyester material having a second glass transition temperature, the second polymer layer having a different polymer composition than the first polymer layer;
heating the multilayer polymer film to a temperature of about or greater than the higher of the first and second polymer layer glass transition temperatures to form a heated multilayer film; and
stretching the heated multilayer polymer film in an in-plane direction to a dimension less than five times that direction's unstretched dimension to form a multilayer reflective polarizer having an optical power in a range from 1.2 to 2.0 per optical layer pair, wherein the stretching step consists essentially of a uniaxial stretch.

18. A method according to claim 17 wherein providing step comprises providing a first polymer layer and a second polymer layer, each first polymer layer comprising polyethylene naphthalate or a copolymer thereof, the second polymer layer comprising polyethylene naphthalate or a copolymer thereof.

19. A method according to claim 17 wherein providing step comprises providing a first polymer layer and a second polymer layer, each first polymer layer comprising polyethylene terephthalate or a copolymer thereof, the second polymer layer comprising polyethylene terephthalate or a copolymer thereof.

20. A method according to claim 17 wherein the stretching step comprises stretching the heated multilayer polymer film in an in-plane direction to a dimension in a range from two to five times that direction's unstretched dimension to form a multilayer reflective polarizer.

21. A method according to claim 17 wherein the stretching step comprises stretching the heated multilayer polymer film in an in-plane direction to a dimension in a range from 3.5 to 4.5 times that direction's unstretched dimension to form a multilayer reflective polarizer.

22. A method according to claim 17 wherein the stretching step comprises stretching the heated multilayer polymer film in an in-plane direction form a multilayer reflective polarizer having an optical power in a range from 1.4 to 1.7 per optical layer pair.

23. A method according to claim 17 wherein the providing step comprises providing a multilayer polymer film having alternating first layers and second layers, the first polymer layer comprising a homopolymer of polyethylene naphthalate and the second polymer layer comprising a copolymer of polyethylene naphthalate.

24. A method according to claim 18 wherein the providing step comprises providing a multilayer polymer film having alternating first polyethylene naphthalate homopolymer layers and second polyethylene naphthalate copolymer layers.

25. A method according to claim 1 further comprising disposing a coating layer on the multilayer polymer film prior to the stretching step, wherein the coating layer exhibits an elongation limit of 500% or less.

26. A method according to claim 9 further comprising disposing a coating layer on the multilayer polymer film prior to the stretching step, the coating layer comprising an anti-static material, wherein the anti-static material retains its anti-static properties following the stretching step.

27. A method according to claim 17 wherein the heating step comprises heating the multilayer polymer film to a temperature in a range from 5 to 40 degrees centigrade greater than the higher of the first and second polymer layer glass transition temperatures.
